(19) United States
(12) Patent Application Publication
(10) Pub. No.: US 2002/0182352 A1
(43) Pub. Date: Dec. 5, 2002

(54) Multi-layer plastic articles and methods of making the same

(76) Inventors: Michael R. Mitten, Wooster, OH (US); Elena Y. Sapatova, Seven Hills, OH (US); John F. Travers, North Royalton, OH (US); Gregory S. Floyd, Wooster, OH (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/154,903

(22) Filed: May 23, 2002

Related U.S. Application Data
(60) Provisional application No. 60/293,078, filed on May 23, 2001.

(51) Int. Cl. B32B 1/02; B29C 51/10; B29C 51/14; B29C 45/16

(52) U.S. Cl. 428/35.7; 264/510; 264/553; 264/265

(57) ABSTRACT

A three-dimensional, multi-layer plastic product that is resistant to damage caused by environmental factors such as heat, chemicals, desiccants, oxygen, and/or weather is disclosed. The multi-layer product includes an engineering resin layer affixed to a commodity resin layer. The engineering resin layer of the multi-layer film may be directly fused to the commodity resin or post-consumer regrind layer. Alternatively, the engineering resin layer may be tied to the commodity resin or post-consumer regrind layer through the use of one or more adhesive and/or tie layers. The commodity resin layer may be manufactured from an economical polymer material such as a polypropylene, polyethylene, polystyrene or post-consumer regrind. Suitable engineering resins may be any of a variety of suitable materials such as a polysulphone, polymethylpentene, polyester, polycarbonate, polyetherimide, nylon, polyarylate, polyphenylenesulphide, polyphenylene oxide, polyethersulphone, aromatic polyketone, liquid crystal polymer, and mixtures thereof, for example, a method for manufacturing a three-dimensional multi-layer plastic product is also disclosed which includes the steps of providing an extruded or laminated sheet comprising an engineering resin layer, thermoforming a three-dimensional shell from the sheet, and injection molding a commodity resin layer onto the thermoformed shell.

### CROSS-REFERENCE TO RELATED APPLICATION

This application claims the benefit under 35 U.S.C. § 119(e) of U.S. provisional patent application Serial No. 60/293,078 filed May 23, 2001, the disclosure of which is incorporated herein by reference.

### BACKGROUND

1. Technical Field

The disclosure relates generally to products comprising resinous plastic materials and methods of making the same. More specifically, multi-layer plastic articles that are resistant to damage and stress caused by a variety of factors are disclosed.

2. Description of the Related Art

A large variety of plastic articles are commonly fabricated from “commodity” resins such as polyethylene, polypropylene, and polystyrene. Such plastic resins have successfully been applied to various home products, including food containers, storage containers, garbage cans, insulated containers, and baby products. These products are popular with consumers because they are economical, lightweight, and useful in many different environments.

One problem associated with such commercially available plastic products relates to their propensity to be damaged by heat, chemicals, desiccants, oxygen, and/or weather. For example, food containers made of polyethylene, polypropylene, and/or other commodity resins frequently stain when used to store and reheat foodstuffs.

With respect to food containers that have been used to store tomato based sauces, staining is a well known problem. Tomato based sauces contain lycopene, a carotenoid pigment responsible for the red color of tomatoes. Under certain conditions of use, lycopene can be deposited on the interior food contacting container surface, causing the food container to take on an unsightly appearance. Other foodstuffs also contain pigments that are capable of staining commercially available plastic products.

Alternatively, pigments such as lycopene may migrate/diffuse into the wall of the plastic container, thereby also causing the food storage container to retain an unattractive reddish orange stain. The elevated temperatures produced during microwave reheating exacerbate such pigment based staining. While such staining occurs at a faster rate at elevated temperatures, e.g., temperatures greater than 65° C., such pigment based staining can also occur at refrigeration temperatures, albeit at a slower rate.

Food storage containers made of polyethylene, polypropylene, and other commodity resins are especially susceptible to staining when vegetable and/or animal based oils are present in the foodstuff that is being stored and/or heated. Such increased staining may occur because the relatively non polar nature of these commodity resin materials allows greater amounts of diffusion of non polar substances (such as oils), which may contain dispersed pigments (e.g., lycopene), into the resin. This diffusion occurs at a slow rate under refrigeration conditions. However, when used in a microwave oven, products made with commodity resins are commonly subjected to temperatures in excess of their heat distortion temperatures. At such increased temperatures, polymer chain mobility is increased, resulting in increased rates of diffusion, and consequently, greater amounts of staining.

Foodstuffs containing sugars and/or oils present special staining difficulties for food storage containers, especially when the foodstuffs are heated in the containers. For example, sugars frequently caramelize at the point where the meniscus contacts the food container surface when a foodstuff (e.g., tomato based sauce) is heated in microwave ovens. Caramelized sugars absorb great amounts of microwave radiation, i.e., they are less transparent to microwave radiation, when compared with the foodstuff itself, which can also typically lose heat through evaporation. Accordingly, caramelized sugars may be heated to temperatures up to about 200° C. Such local “superheating” at the inner surface of the container can stain, melt, scar, and/or burn the inner surface of the container. The damage caused by this sort of phenomenon is sometimes referred to as “pitting.”

Chemical staining caused by tomato based foods or other food products, as well as damage caused by local superheating, is undesirable to consumers because these containers, which are intended to be reused repeatedly, become unsightly. Accordingly, efforts have been made to reduce or eliminate the staining that frequently occurs in reusable plastic food storage containers.

The use of food storage containers fabricated from “engineering” resins made up of more rigid polymers can limit the staining phenomena described above. Engineering plastics are characterized by better heat resistance, higher impact strength, high stiffness, and/or many other “improved” properties. Some engineering resins, because of their high rigidity and decreased chain mobility, have a substantially reduced rate of diffusion when compared with commodity resins. Therefore, pigments such as lycopene do not migrate into an engineering resin to the extent observed in a product made from a commodity resin.

However, engineering resins can be very expensive. Furthermore, because of more limiting processing requirements, it is expensive to manufacture containers from engineering resins such as polycarbonate. For example, multi-cavitation injection molding of polycarbonate articles manufactured from typical low melt flow polycarbonate materials has proven to be difficult because the ratio of flow distance to wall stock is too high to adequately fill multi-cavitation molds.

The phenomenon referred to as environmental stress cracking (“ESC”) represents the susceptibility of a thermoplastic part to crack or craze formation under the influence of certain chemicals, aging, weather, and/or stress. It is not desirable to use higher melt flow polycarbonate materials (which would allow for the filling of multi-cavitation molds) in the manufacture of plastic articles because of their vulnerability to environmental stress cracking and their inferior stain-resistant properties.

Consequently, containers made solely from engineering resins are not popular with the general consumer because they are either substantially more expensive than plastic containers made solely from inexpensive commodity resins and/or do not exhibit satisfactory resistance to damage caused by environmental factors, e.g., environmental stress cracking resistance and stain resistance.

One attempt at providing a reusable, stain resistant food storage container is disclosed in International Publication No. WO 00/38917 (Jul. 6, 2000). This publication discloses a two layer structure including an inner, stain resistant layer and an outer, heat durable layer. The inner, stain resistant layer of polyetherimide, polyethersulphone, or polyphenylenesulphide is bonded to an outer, heat durable layer of liquid crystal polymer, aromatic polyketone, polyarylate, polyphthalamide, or poly(cyclohexylene dimethylene terephthalate).

An attempt at providing reusable, stain resistant microwave cookware is disclosed in U.S. Pat. No. 4,772,653 (Sep. 20, 1988). This patent discloses cookware fabricated from a blend of at least two materials, which is both stain resistant and heat resistant. The blend includes an interpolymer formed from unsaturated dicarboxylic acid compounds and vinyl monomers, and at least one thermoformable polymer such as polycarbonate, poly(aryl ether) resins, polyarylates and polyetherimides.

While certain food storage and/or cookware containers that provide stain resistance are known, no formulation or structure has been developed which provides an inexpensive container, cookware article, or home consumer product that can be manufactured at a cost that is competitive with products made from commodity resins, that is acceptable to the home consumer, and that exhibits adequate environmental stress cracking resistance.

Similarly, no three-dimensional plastic article that resists damage caused by a variety of environmental factors, and that can be manufactured at a cost that is competitive with products made from commodity resins has been developed.

### SUMMARY OF THE DISCLOSURE

Plastic structures comprising multi-layer films, which are resistant to damage caused by a variety of environmental factors, and methods of making the same are disclosed.

More specifically, three-dimensional, multi-layer plastic articles including at least one engineering resin layer and at least one commodity resin layer, and methods of making the same are disclosed.

A method of manufacturing a three-dimensional, multi-layer article including the steps of providing a sheet formed from an engineering resin layer, forming a three-dimensional shell from the extruded sheet, and molding a commodity resin layer onto the shell is disclosed.

The disclosed products may be produced through a variety of methods.

Other advantages and refinements of the disclosed products and manufacturing methods will be apparent from a review of the following detailed description and drawings.

### BRIEF DESCRIPTION OF THE DRAWINGS

Other aspects of the disclosed three-dimensional, multi-layer articles and methods of making the same will become apparent with reference to the accompanying drawings, in which:

FIG. 1 illustrates the co-extrusion of a multi-layer film according to the disclosure, and a detailed cross section of multiple embodiments of a multi-layer film for manufacturing three-dimensional, multi-layer articles according to the disclosure;

FIG. 2 illustrates a multi-layer film in accordance with the disclosure, which has been formed into a three-dimensional structure;

FIG. 3 illustrates a preferred manner in which a three-dimensional, multi-layer article is formed through injection molding over a preformed three-dimensional thermoformed shell;

FIG. 4 illustrates a cross sectional view of an article formed from the multi-layer film of FIG. 1;

FIG. 5 is a cross sectional view of a lid for a container formed from the multi-layer film of FIG. 1;

FIGS. 6a-6c are flow chart diagrams showing some alternate methods of manufacturing multi-layer articles according to the disclosure.

### DETAILED DESCRIPTION OF THE DISCLOSURE

Three dimensional plastic articles that are both economical to manufacture and capable of resisting damage and stress caused by a variety of factors are disclosed. Accordingly, the disclosed products may be marketed to consumers who are accustomed to low priced plastic products manufactured solely from commodity resins, while simultaneously providing the damage resistance/protective benefits of engineering resins.

Articles comprising a multi-layer film including a thin layer of engineering resin affixed to a layer of commodity resin are disclosed. Preferably, the articles are reusable.

The engineering resin layer may be directly fused to the commodity resin layer. In another refinement of the disclosure, the three-dimensional multi-layer article comprises at least one tie layer disposed between the engineering resin layer and the commodity resin layer. In a further refinement, at least one adhesive layer is disposed between the engineering resin layer and the commodity resin layer

Articles comprising a multi-layer film according to the disclosure may be manufactured through a variety of methods including, without limitation, injection molding, injection stretch blow molding, thermoforming, extrusion blow molding, insert molding, co-injection molding, rotational molding, and other methods known in the art.

In an additional refinement of the disclosure, the multi-layer articles provide aesthetical benefits to consumers by including embossed or ink patterns between the engineering and commodity resin layers.

The disclosure also provides methods for manufacturing three-dimensional plastic articles. One such method includes the steps of providing an extruded sheet comprising an engineering resin layer, thermoforming a three-dimensional shell from the extruded sheet, and injection molding a commodity resin layer onto the thermoformed shell.

Preferably, the commodity resin is injection molded over the exterior surface of the thermoformed shell. Alternatively, if the exterior surface of the article of the disclosure is intended to possess the protective benefits of the engineering resin layer, the commodity resin layer can be injection molded onto the interior surface of the thermoformed shell so that the engineering resin layer is on the outside surface of the manufactured article.

Further, in an additional refinement of a method in accordance with the disclosure, a three-dimensional shell may be formed from an extruded sheet comprising a commodity resin layer, and an engineering resin layer can be injection molded over the exterior surface or onto the interior surface of the thermoformed shell.

Another method of the disclosure includes the steps of providing an extruded sheet comprising an engineering resin layer and a first commodity resin layer, thermoforming a three-dimensional shell from the extruded sheet, and injection molding a second commodity resin layer onto the first commodity resin layer of the thermoformed shell. In this method, a tie layer may be disposed between the engineering resin layer and the first commodity resin layer. Alternatively, or in conjunction with the tie layer, an adhesive layer may be disposed between the engineering resin layer and the first commodity resin layer.

In a further refinement of a method of the disclosure, the commodity resin layer of the extruded sheet can include two layers of like, i.e., compatible material. Specifically, the article may be fabricated from an extruded sheet that comprises an engineering resin layer affixed to a first commodity resin layer by way of a chemical bond (for example, by virtue of the two materials melting together), adhesive layers, and/or tie layers. The extruded sheet further comprises a second commodity resin layer, which is in contact with the first commodity resin layer. Typically, the multi-layer extruded sheet is thermoformed to form a three-dimensional shell so that the second commodity resin layer provides an outer wall to the thermoformed shell. An additional outer commodity resin layer is injection molded over the outer layer of the thermoformed shell, i.e., the second commodity layer of the thermoformed shell.

In another refinement, the method of the disclosure includes the steps of extruding a sheet comprising an engineering layer, thermoforming a three-dimensional shell from the extruded sheet, and injection molding a commodity resin layer onto the thermoformed shell. Alternatively, a sheet comprising a commodity resin layer can be extruded, thermoformed into a three dimensional shell, and an engineering resin can be injection molded onto the shell.

In another refinement, the method of the disclosure includes the steps of co-extruding a sheet comprising multiple layers, wherein the sheet comprises an engineering resin layer and a first commodity resin layer, thermoforming a three-dimensional shell from the extruded sheet, and injection molding a second commodity resin layer onto the first commodity resin layer of the thermoformed shell.

In yet another refinement, the disclosure encompasses the method of utilizing an extruded film to make multi-layer plastic products from processes such as injection molding, injection stretch blow molding, extrusion blow molding, insert molding, co-injection molding, rotational molding, and other molding methods known in the art.

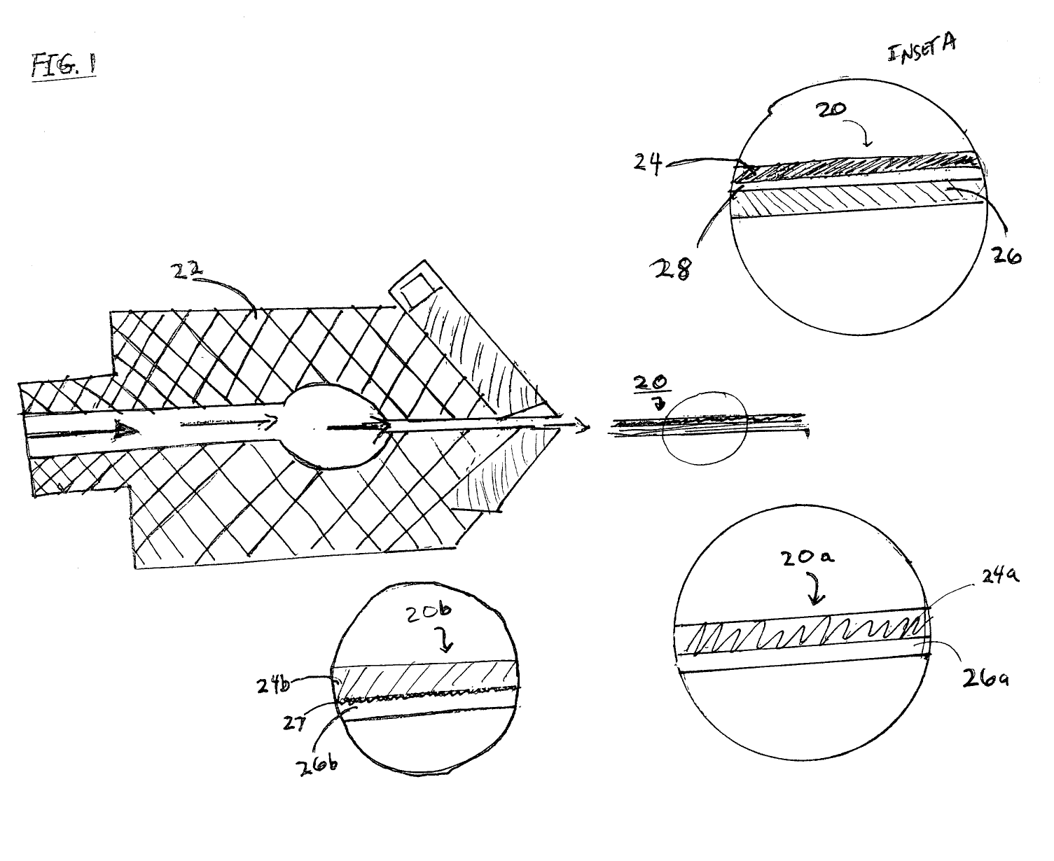

Referring to FIG. 1, a multi-layer film 20 is co-extruded through an extruder 22. As is better seen in the inset of FIG. 1, the multi-layer film 20 includes an engineering resin layer 24 tied to a commodity resin layer 26 by means of tie layer 28. As mentioned above, an adhesive layer may be disposed in conjunction with or as a substitute for tie layer 28. The thickness of the extruded multi-layer film 20 can be a variety of ranges depending on the intended usage; however, the thickness of the extruded multi-layer film 20 is preferably about 0.006 inches to about 0.250 inches. More preferably, the range of thickness for the extruded multi-layer film is about 0.021 inches to about 0.031 inches.

The engineering resin of engineering resin layer 24 is selected based on the desired performance that the plastic product is to achieve (e.g., stain resistance, oxygen or other gas resistance, thermal resistance, weather resistance, chemical resistance, environmental stress crack resistance, etc.). Engineering resins that are known for their capabilities to absorb or resist elements such as water and/or oxygen and other gases may be used in the multi-layer articles of the disclosure. Typically, the engineering resin comprises at least one amorphous resinous or crystalline resinous material.

Amorphous resinous materials for use as the engineering resin layer typically have glass transition temperatures greater than or equal to about 110° C. Preferably, resinous materials have glass transition temperatures greater than or equal to about 125° C. Even more preferably, resinous materials have glass transition temperatures greater than or equal to about 140° C.

Amorphous resinous materials for use as the engineering resin layer include polysulphones, polyesters, polycarbonates, polyetherimides, nylons, polyarylates, polyphenylenes oxides, polyethersulphones, and mixtures thereof.

Crystalline resinous materials for use as the engineering resin layer typically have melting temperatures greater than or equal to about 160° C. Preferably, crystalline resinous have melting temperatures greater than or equal to about 170° C. Even more preferably, crystalline resinous materials have melting temperatures greater than or equal to about 180° C.

Crystalline resinous materials for use as the engineering resin layer include polymethylpentenes, polyesters, nylons, polyphenylenesulphides, aromatic polyketones, liquid crystal polymers and mixtures thereof. Polyester and nylon materials may be amorphous or crystalline, depending on processing conditions.

Accordingly, the engineering resin layer material is typically selected from the group consisting of polysulphones, polymethylpentenes, polyesters, polycarbonates, polyetherimides, nylons, polyarylates, polyphenylenesulphides, polyphenylene oxides, polyethersulphones, aromatic polyketones, liquid crystal polymers and mixtures thereof. This list is not intended to be exhaustive, but is merely demonstrative of the variety of engineering resins that are available to be used in accordance with this disclosure.

Polycarbonate materials are preferred for use as the engineering resin layer when heat resistance and/or stain resistance properties are desired. The polycarbonate material may comprise polyestercarbonate. Examples of polycarbonate materials for use as the engineering resin layer in multi-layer articles of the disclosure include compounds having the following chemical formula:

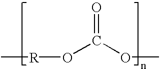

Additionally, U.S. Pat. No. 4,880,855, discloses numerous dihydric phenols that may be reacted with phosgene (or other carbonate precursors) to provide polycarbonate materials suitable for use as engineering resin layers in the multi-layer articles of the disclosure. The dihydric phenols which may be employed to provide such carbonate polymers are mononuclear or polynuclear aromatic compounds, containing as functional groups two hydroxy radicals, each of which is attached directly to a carbon atom of an aromatic nucleus. Typical dihydric phenols are: 2,2 bis(4 hydroxyphenyl)propane; hydroquinone; resorcinol; 2,2 bis (4 hydroxyphenyl)pentane; 2,4′ dihydroxydiphenylmethane; bis (2 hydroxyphenyl)methane; bis (4 hydroxyphenyl)methane; bis (4 hydroxy 5 nitrophenyl)methane; 1,1 bis,(4 hydroxyphenyl)ethane; 3,3 bis(4 hydroxyphenyl)pentane; 2,2 dihydroxydiphenyl; 2,6 dihydroxynaphthalene; bis (4 hydroxydiphenyl)sulfone; bis (3,5 diethyl 4 hydroxyphenyl)sulfone; 2,2 bis (3,5 dimethyl 4 hydroxyphenyl)propane; 2,4′ dihydroxydiphenyl sulfone; 5′ chloro 2,4′ dihydroxydiphenyl sulfone; bis (4 hydroxyphenyl)diphenyl sulfone; 4,4′ dihydroxydiphenyl ether; 4,4′ dihydroxy 3,3′ dichlorodiphenyl ether; 4,4′ dihydroxy 2,5 dihydroxydiphenyl ether; and the like. Other dihydric phenols, which are also suitable for use in the preparation of the above polycarbonates are disclosed in U.S. Pat. Nos. 2,999,835; 3,028,365; 3,334,154; and 4,131,575.

These polycarbonates can be manufactured by known processes, such as, for example and as mentioned above, by reacting a dihydric phenol with a carbonate precursor, such as phosgene, in accordance with methods set forth in the above cited patents as well as U.S. Pat. Nos. 4,018,750 and 4,123,436, or by transesterification processes such as are disclosed in U.S. Pat. No. 3,153,008, as well as other processes known to those skilled in the art.

It is possible to employ two or more different dihydric phenols or a copolymer of a dihydric phenol with a glycol or with a hydroxy or acid terminated polyester or with a dibasic acid in the event a carbonate copolymer or interpolymer rather than a homopolymer is desired for use. Branched polycarbonates are also useful, such as are described in U.S. Pat. No. 4,001,184. Blends of a linear polycarbonate and a branched polycarbonate may also be used. Moreover, blends of any of the above materials may be employed to provide the polycarbonate materials suitable for use as the engineering resin layer.

Preferably, polycarbonate materials for use as the engineering resin layer are derived from bis phenols. More preferably, polycarbonates derived from bis phenol A (2,2 bis(4-hydroxyphenyl)propane), bis phenol TMC (trimethylenecyclohexane bisphenol), and mixtures thereof are used as the engineering resin layer. Most preferably, polycarbonates derived from bis-phenol A are used.

As used herein, the term polyester excludes polycarbonate materials, i.e., molecules having a carbonate linkage. Examples of polyester material suitable for use as the engineering layer include compounds having the following chemical formula:

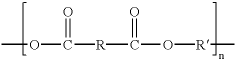

Suitable polyesters may be derived from an aliphatic, aliphatic ether, or cycloaliphatic diol, containing from 2 to about 10 carbon atoms and one or more aromatic or cycloaliphatic dicarboxylic acids. One preferred polyester is derived from an aliphatic diol and an aromatic dicarboxylic acid. Specific among these are the poly(alkylene terephthalates, i.e., poly(ethylene terephthalate) and poly(butylene terephthalate). Polyesters derived from dimethyl terephthalate or terephthalic acid are preferred.

More specifically, polyesters for use as the engineering resin layer include polyethylene terephthalate (PET), polyethylene terephthalate, glycol (PETG), polydihydroxymethylcyclohexyl terephthalate, polycyclohexylenedimethylene terephthalate, glycol (PCTG), polycyclohexylenedimethylene terephthalate, acid (PCTA), unsaturated polyesters, aromatic polyesters, and mixtures thereof.

Nylon materials intended for use as the engineering resin layer may be selected from the group consisting of crystalline copolymers, amorphous copolymers, and mixtures thereof.

The engineering resin layer 24 may be tied to a commodity resin layer 26 through the use of a tie layer 28. In general, the tie layer 28 is capable of bonding to both the engineering resin layer 24 and the commodity resin layer 26. Tie layer resins may be modified polyolefins with functional groups such as ADMER® resins (Mitsui Chemicals America, Inc., Purchase, N.Y.), modified ethylene vinyl acetate polymers such as BYNEL® resins (DuPont Company, Wilmington, Del.), ethylene vinyl acetate copolymers and terpolymers blended with petroleum waxes and resin tacifiers such as ELVAX® EVA resins (DuPont Company, Wilmington, Del.), ethylene methyl acrylate copolymer resins such as EMAC® copolymer resins (Eastman Chemical Company, Kingsport, Tenn.), and thermoplastic elastomer resins such as thermoplastic vulcanizates, for example, Santoprene 8211-55B100 (Advanced Elastomer Systems, Akron, Ohio). The tie layer must be compatible with a co-extrusion process, and capable of bonding to the commodity and engineering resins listed above.

In another refinement of the disclosure, two or more tie layers can be used to adhere the engineering resin layer to the commodity resin layer. Typically, the first tie layer is selected because it adheres well to the commodity resin layer and the second tie layer, and the second tie layer is selected because it adheres well to the first tie layer and the engineering resin layer. When one or more tie layers are used to adhere the engineering resin layer to the commodity resin layer, additional tie layers such as, polyester materials derived from dimethyl terephthalate or terephthalic acid such as, for example, polyethylene terephthalate, copolyester materials derived from dimethyl terephthalate or terephthalic acid such as polyethylene terephthalate, glycol (PETG), polycyclohexylenedimethylene terephthalate, glycol (PCTG), and polycyclohexylenedimethylene terephthalate, acid (PCTA), and copolyester/polycarbonate alloys or blends such as, for example, EastAlloy® polymers (Eastman Chemical Company, Kingsport, Tenn.), and Xylex™ resins (General Electric Company, GE Plastics, Pittsfield, Mass.), may also be used (in addition to the tie layers referenced supra) to adhere the engineering layer to the first tie layer.

Similarly, three tie layers may also be used to adhere the commodity resin layer to the engineering resin layer. The first tie layer is again selected because it adheres well to the commodity resin layer and the second tie layer, the second tie layer is selected because it adheres well to the first tie layer and the third tie layer, and the third tie layer is selected because it adheres well to the second tie layer and the engineering resin layer. Additional tie layers may also be used to adhere the commodity resin layer to the engineering resin layer.

For multi-layer films produced by co-extrusion, additives including polyolefin plastomers such as Exact plastomers (ExxonMobil Chemical Company, Houston, Tex.), styrene block copolymers, for example, polystyrene ethylene butylene styrene block copolymers, and others commercially available, for example under the trade name Kraton (Kraton Polymers, Houston, Tex.), polyester elastomers such as Hytrel (DuPont Company, Wilmington, Del.), and thermoplastic elastomer resins such as thermoplastic vulcanizates, for example, Santoprene 8211-55B100 (Advanced Elastomer Systems, Akron, Ohio) can be added to the commodity resin, engineering resin, and/or tie layers to increase adhesion between the various layers. Typically, additives are added in an amount from about 0.1 wt. % to about 5.0 wt. % (based upon the total weight of the specific resin/tie layer) when used. Preferably, additives are added in an amount from about 0.5 wt. % to about 3.0 wt. % when used. Even more preferably, about 1.5 wt. % of additives is added to one or more of the resins and tie layers before co-extrusion in order to increase adhesion between the various layers.

Adhesive layers that may successfully be used to adhere the engineering resin layer to the commodity resin layer include epoxy-based adhesives, urethane-based adhesives, acrylic-based adhesives, and the like.

It will also be noted that the use of a tie and/or adhesive layer may not be necessary, depending upon the materials chosen for the engineering resin layer 24 and the commodity resin layer 26. As seen in FIG. 1, the multi-layer film 20a may be formed by directly fusing an engineering resin 24a directly to a commodity resin layer 26a. The multi-layer film 20a of this embodiment may be formed when the engineering resin 24a and the commodity resin 26a are compatible enough such that the resins do not delaminate apart after extrusion and microwave reheating.

In a further embodiment of the multi-layer film 20b, the commodity resin layer 26b may be embossed with a decorative design 27 prior to extruding the engineering resin over the commodity resin layer 26b to form engineering resin layer 24b. Alternatively, the commodity resin layer 26b may be embossed with a decorative design 27 prior to laminating the engineering resin layer 24b over the commodity resin layer 26b. Similarly, the engineering resin layer may be embossed with a decorative design prior to extrusion or lamination of the commodity resin layer. The embossed design 27 may further include ink to further enhance the decorative design. The inclusion of design 27 in the multi-layer film 20b provides an aesthetic appeal.

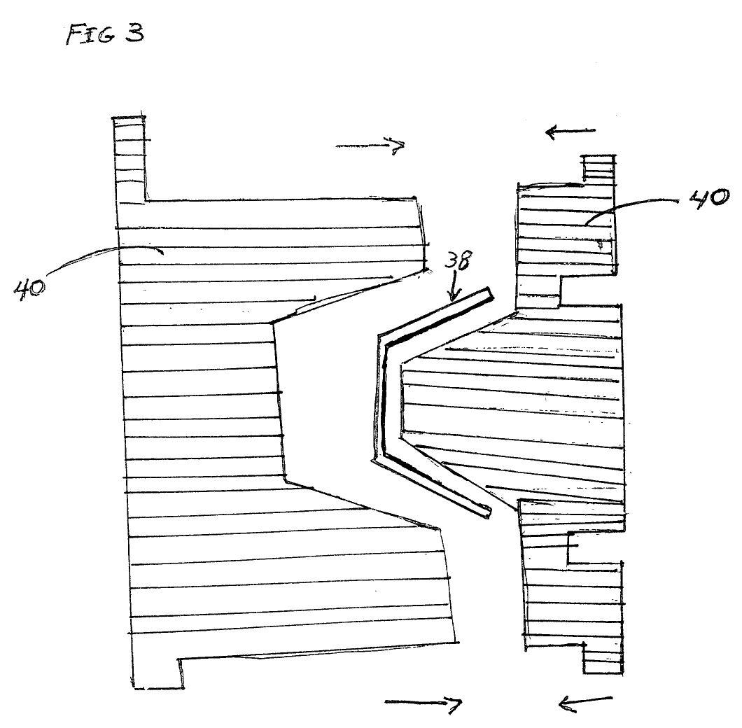

The commodity resin layer 26 for all embodiments of the multi-layer films 20, 20a, and 20b is preferably polyethylenes, polypropylenes, polystyrenes, post-consumer regrinds, or mixtures thereof. More preferably, the commodity resin layer comprises polyethylene, polypropylene, or mixtures thereof. However, as a further cost savings, the commodity resin layer 26 may also be a post-consumer regrind. Many plastic products are presently made of polyethylene and polypropylene, due to the inexpensive nature of these materials as well as their durability. By including a first commodity resin layer comprising, for example, polyethylene or polypropylene in the multi-layer film, the film can be directly bonded by injection molding a second commodity resin layer over or onto the insert, such as is shown in FIG. 3. Other suitable techniques can also be used to mold the second commodity resin layer over or onto an insert, as previously set forth.

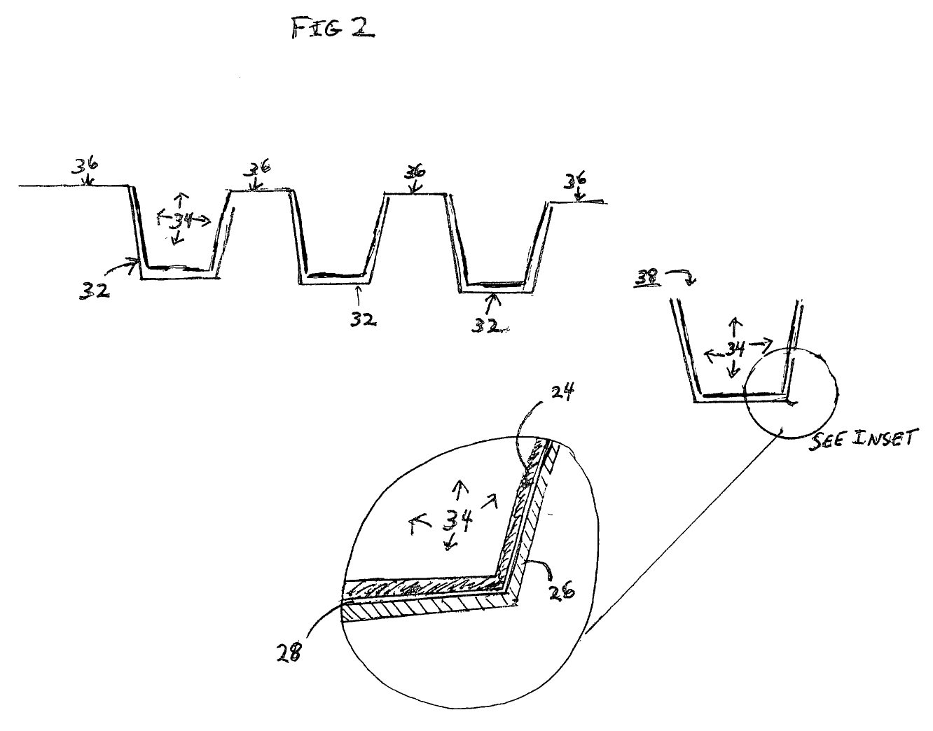

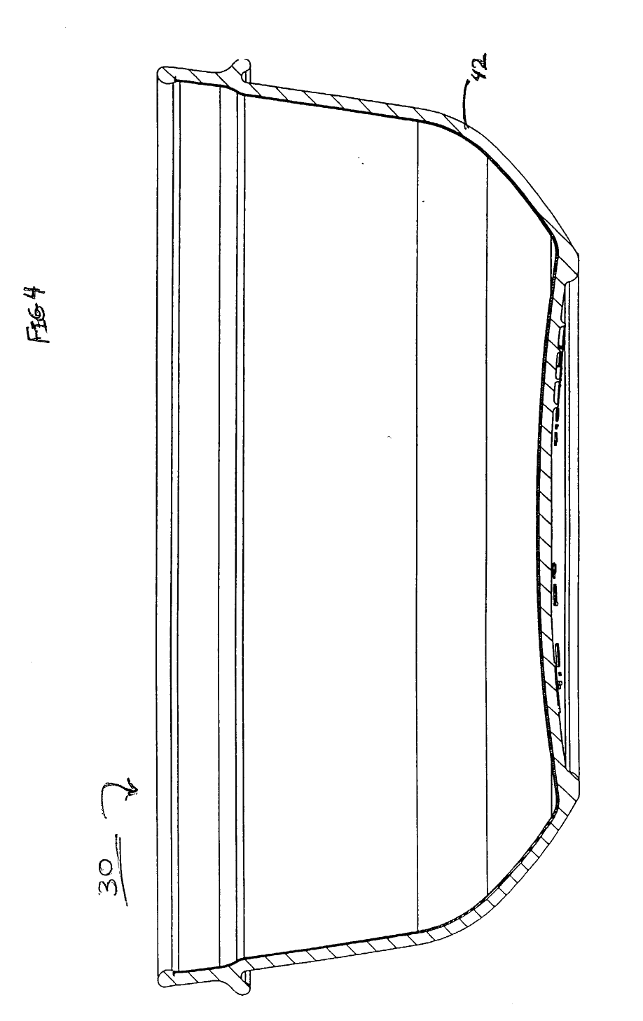

Referring now to FIG. 2, the next step in creating a multi-layer product 30 (see FIG. 4) typically involves thermoforming the multi-layer film 20 into three-dimensional shapes 32. Typically, the engineering resin layer 24 is on the inside 34 of the three-dimensional shape 32 as illustrated in FIG. 2, to protect the interior of the product from adverse environmental conditions. According to this refinement of the disclosure, multi-layer articles are provided that exhibit superior resistance to chemicals (including chemical staining and pitting, as set forth above), environmental stress cracking, heat, desiccants, and/or oxygen. In one preferred embodiment of this refinement of the disclosure, the article comprises a food storage container.

After forming the three-dimensional shape 32, remaining flash portions 36 of excess film are removed and discarded. A resulting insert 38 is a relatively thin three-dimensional shape with the engineering resin layer 24 on the one side 34 and the commodity resin layer 26 on the other side of the insert 38. Although side 34 of the insert is shown in FIG. 2 as the inside (i.e., the interior surface of the insert is an engineering resin layer), it may be formed on the outside surface of the insert, if the intended use calls for protection of the outside of the product 30. Accordingly, the thin engineering resin layer is exposed to the adverse environmental conditions that ultimately damage the plastic product, thereby protecting the plastic article from becoming damaged. The commodity resin layer is directly exposed only to inert environmental conditions.

End uses of articles according to the disclosure which call for protection of the outside of the product include applications where resistance to adverse environmental conditions such as heat, chemicals, desiccants, oxygen, and/or weather is desired. In one preferred embodiment of this refinement of the disclosure, the article comprises an outdoor plastic product, e.g., an outdoor storage shed or a garbage can.

Accordingly, by providing an engineering resin layer which is resistant to damage caused by environmental conditions such that during use of the article the engineering resin layer is exposed to the damaging, adverse environmental conditions, and the commodity layer is only exposed to inert conditions, a plastic article is provided that is protected from damage caused by various environmental factors such as heat, chemicals, desiccants, oxygen, and weather.

As shown in FIG. 3, the insert 38 is placed within the injection mold 40. Upon closing the injection mold 40, melted commodity resins such as polyethylene, polypropylene, polystyrene, post-consumer regrind, or mixtures thereof are then introduced into the injection mold 40 to form the final multi-layer product 30 (see FIG. 4).

Due to the fact that a first commodity resin layer 26 of the multi-layer film 20 is on the outside of the insert 38 (as illustrated by FIG. 3), the insert 38 is bonded to the second commodity resin which is introduced as melt flow into the injection mold 40. The final multi-layer product 30 therefore has an outside layer 42 which is directly bonded to the like or compatible material of the commodity resin layer 26 of the multi-layer film 20, which is then directly tied to the engineering resin layer material 24 through the use of a tie layer 28.

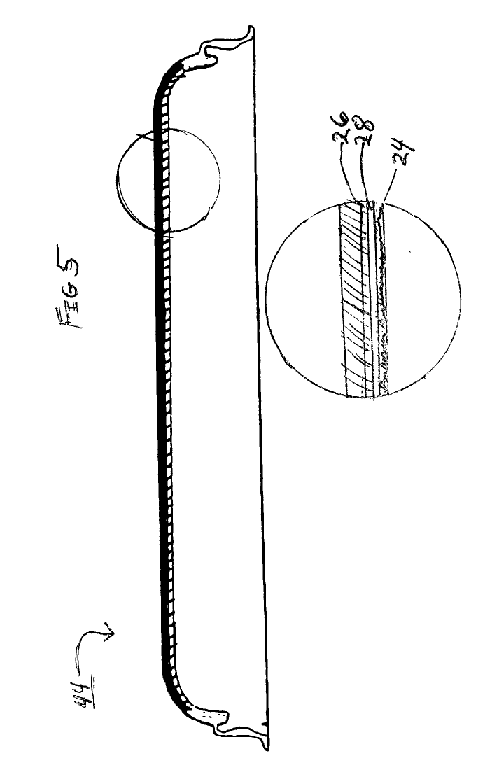

Referring now to FIG. 5, a multi-layer lid 44, which is intended to be used with the multi-layer product 30, is produced in a similar fashion. First, a multi-layer film 20 as shown in FIG. 1 comprising an engineering resin layer and a commodity resin layer according to the disclosure is produced. When creating a multi-layer lid 44, film 20 is thermoformed into a three-dimensional insert, which has a shape similar to that of the lid 44. The insert formed in the shape of the lid is then inserted into an injection mold. Melted commodity resin is then introduced into the mold onto the commodity resin layer of the thermoformed shell, and the final multi-layer lid 44 is formed.

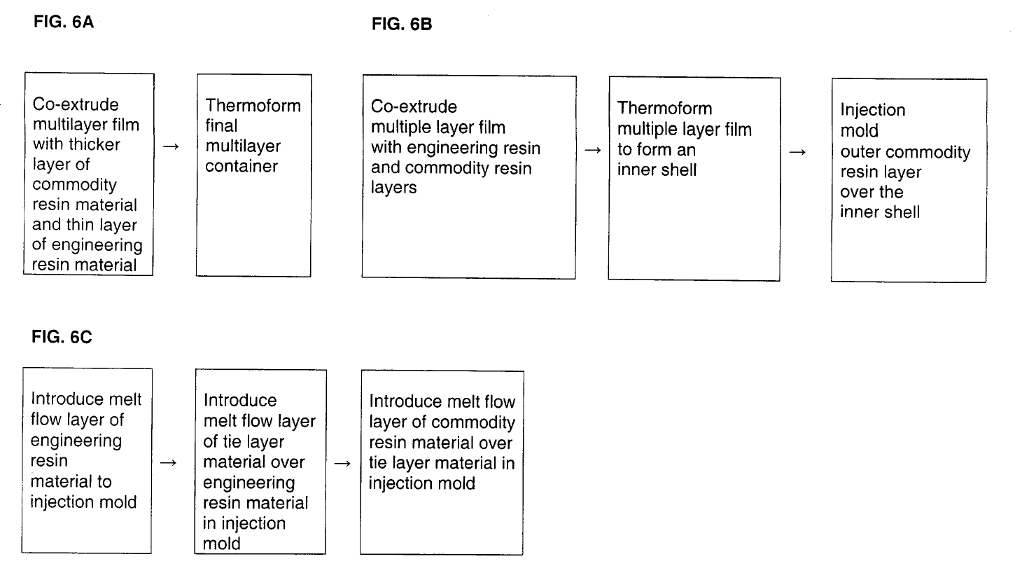

FIG. 6a is a flow chart indicating the steps of an alternative method for producing a multi-layer product 30 according to the disclosure. The first step in this method would be to co-extrude the multi-layer film as in FIG. 1. However, according to the method outlined in FIG. 6a, the commodity resin layer 26 would typically be much thicker. Thus, the overall thickness of the multi-layer film would be at least 0.03 inches. The final step in this method is to thermoform the thicker multi-layer film 20 into the shape of the final product 30. The advantage of this method is that the injection molding step described in FIG. 6b is completely eliminated.

FIG. 6b is a flow chart indicating the steps that are performed to produce a multi-layer article through co-extrusion, thermoforming, and injection molding. This method and variants thereof have already been discussed in some detail supra.

FIG. 6c is also a flow chart showing another alternative method of producing a multi-layer product 30 according to the disclosure. In this method, the multi-layer product 30 could be produced through multiple stages of the injection molding process. In such a process, the engineering resin material 24 would be introduced as melt flow into the injection mold 40. Then a melt flow of the tie layer 28 would be introduced to the injection mold 40 over the top of the engineering resin layer 24. Finally, a melt flow of the commodity resin 26 would be introduced over the top of the tie layer 28. Due to the fact that the product 30 is formed inside the injection mold 40 by introducing the various layers, it is not necessary to co-extrude and thermoform the multi-layer film 20 as with the previous methods.

The multi-layer film 20 of the disclosure can also be used to produce products according to blow molding processes as well. Such processes such as injection stretch blow molding, extrusion blow molding, and rotational molding are well known in the art.

Although the foregoing text sets forth a detailed description of numerous different embodiments, it should be understood that the legal scope of this disclosure is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the following claims.

We claim:

1. A three-dimensional, multi-layer article comprising:
an engineering resin layer affixed to a commodity resin layer, wherein the engineering resin layer comprises a material selected from the group consisting of amorphous resinous materials and crystalline resinous materials.

2. The article of claim 1, wherein the engineering resin layer is an amorphous resinous material having a glass transition temperature greater than or equal to about 110° C.

3. The article of claim 1, wherein the engineering resin layer is a crystalline resinous material having a melting temperature greater than or equal to about 160° C.

4. The article of claim 1, wherein the article comprises a food storage container.

5. The article of claim 1, wherein the engineering resin layer comprises a material selected from the group consisting of polysulphones, polymethylpentenes, polyesters, polycarbonates, polyetherimides, nylons, polyarylates, polyphenylenesulphides, polyphenylene oxides, polyethersulphones, aromatic polyketones, liquid crystal polymers, and mixtures thereof.

6. The article of claim 1, wherein the engineering resin layer is a polycarbonate.

7. The article of claim 6, wherein the polycarbonate is a polyestercarbonate.

8. The article of claim 1, wherein the engineering resin layer is a nylon selected from the group consisting of crystalline copolymers, amorphous copolymers, and mixtures thereof.

9. The article of claim 1, further comprising a tie layer disposed between the engineering resin layer and the commodity resin layer.

10. The article of claim 9, wherein the tie layer comprises a material selected from the group consisting of functionalized polyolefins, ethylene vinyl acetates, modified ethylene vinyl acetates, ethylene methyl acrylates, ethylene butyl acrylates, elastomers, and mixtures thereof.

11. The article of claim 1, further comprising an adhesive layer disposed between the engineering resin layer and the commodity resin layer.

12. The article of claim 11, wherein the adhesive layer comprises a material selected from the group consisting of epoxy-based adhesives, urethane-based adhesives, and acrylic-based adhesives.

13. The article of claim 1, wherein the commodity resin layer comprises a material selected from the group consisting of polypropylenes, polyethylenes, polystyrenes, post-consumer regrinds, and mixtures thereof.

14. The article of claim 1, wherein the commodity resin layer comprises two layers of compatible material.

15. The article of claim 14, wherein the two layers of the commodity resin layer comprise materials selected from the group consisting of polypropylenes, polyethylenes, polystyrenes, post-consumer regrinds, and mixtures thereof.

16. The article of claim 1, wherein the article comprises a receptacle having an open top;
the commodity resin layer provides an outer wall for the receptacle; and, the engineering resin layer provides an inner surface for the receptacle.

17. The article of claim 16, further comprising a lid that detachably engages the open top of the receptacle to provide a seal.

18. The article of claim 17, wherein the lid comprises an engineering resin layer affixed to a commodity resin layer, and the engineering resin layer of the lid faces the engineering resin layer of the receptacle when the lid is engaged.

19. A three-dimensional, multi-layer article comprising:
an engineering resin layer;
a tie layer; and,
a commodity resin layer,
wherein the tie layer is disposed between the engineering resin layer and the commodity resin layer, and the commodity resin layer comprises a material selected from the group consisting of polypropylenes, polyethylenes, polystyrenes, post-consumer regrinds, and mixtures thereof.

20. The article of claim 19, wherein the engineering resin layer comprises a material selected from the group consisting of polysulphones, polymethylpentenes, polyesters, polycarbonates, polyetherimides, nylons, polyarylates, polyphenylenesulphides, polyphenylene oxides, polyethersulphones, aromatic polyketones, liquid crystal polymers, and mixtures thereof.

21. The article of claim 19, wherein the engineering resin layer is a polycarbonate.

22. The article of claim 21, wherein the polycarbonate is a polyestercarbonate.

23. The article of claim 19, wherein the tie layer comprises a material selected from the group consisting of functionalized polyolefins, ethylene vinyl acetates, modified ethylene vinyl acetates, ethylene methyl acrylates, ethylene butyl acrylates, elastomers, and mixtures thereof.

24. A three-dimensional, multi-layer article comprising:
an engineering resin layer;
a first tie layer;
a second tie layer; and,
a commodity resin layer,
wherein the first and second tie layers are disposed between the engineering resin layer and the commodity resin layer, and the commodity resin layer comprises a material selected from the group consisting of polypropylenes, polyethylenes, polystyrenes, post-consumer regrinds, and mixtures thereof.

25. The article of claim 24, wherein the first tie layer comprises a material selected from the group consisting of functionalized polyolefins, ethylene vinyl acetates, modified ethylene vinyl acetates, ethylene methyl acrylates, ethylene butyl acrylates, elastomers, and mixtures thereof, and the second tie layer comprises a material selected from the group consisting of functionalized polyolefins, ethylene vinyl acetates, modified ethylene vinyl acetates, ethylene methyl acrylates, ethylene butyl acrylates, elastomers, polyester materials derived from dimethyl terephthalate or terephthalic acid, copolyester materials derived from dimethyl terephthalate or terephthalic acid, copolyester/polycarbonate alloys or blends, and mixtures thereof.

26. A method of manufacturing a three-dimensional, multi-layer article comprising:
providing an extruded sheet comprising an engineering resin layer;
thermoforming a three-dimensional shell from the extruded sheet; and,
injection molding a commodity resin layer onto the thermoformed shell.

27. The method of claim 26, wherein the engineering resin layer comprises a material selected from the group consisting of polysulphones, polymethylpentenes, polyesters, polycarbonates, polyetherimides, nylons, polyarylates, polyphenylenesulphides, polyphenylene oxides, polyethersulphones, aromatic polyketones, liquid crystal polymers, and mixtures thereof.

28. The method of claim 26, wherein the extruded sheet further comprises a commodity resin layer.

29. The method of claim 28, wherein the extruded sheet further comprises a tie layer disposed between the engineering resin layer and the commodity resin layer.

30. The method of claim 29, wherein the tie layer comprises a material selected from the group consisting of functionalized polyolefins, ethylene vinyl acetates, modified ethylene vinyl acetates, ethylene methyl acrylates, ethylene butyl acrylates, elastomers, and mixtures thereof.

31. The method of claim 26, wherein the commodity resin layer comprises a material selected from the group consisting of polypropylenes, polyethylenes, polystyrenes, post-consumer regrinds, and mixtures thereof.

32. A method of manufacturing a three-dimensional, multi-layer article comprising:
providing a laminated sheet comprising an engineering resin layer;
thermoforming a three-dimensional shell from the laminated sheet; and,
injection molding a commodity resin layer onto the thermoformed shell.

33. The method of claim 32, wherein the engineering resin layer comprises a material selected from the group consisting of polysulphones, polymethylpentenes, polyesters, polycarbonates, polyetherimides, nylons, polyarylates, polyphenylenesulphides, polyphenylene oxides, polyethersulphones, aromatic polyketones, liquid crystal polymers, and mixtures thereof.

34. The method of claim 32, wherein the laminated sheet further comprises a commodity resin layer.

35. The method of claim 34, wherein the laminated sheet further comprises an adhesive layer disposed between the engineering resin layer and the commodity resin layer.

36. The method of claim 35, wherein the adhesive layer comprises a material selected from the group consisting of epoxy-based adhesives, urethane-based adhesives, and acrylic-based adhesives.

37. The method of claim 32, wherein the commodity resin layer comprises a material selected from the group consisting of polypropylenes, polyethylenes, polystyrenes, post-consumer regrind and mixtures thereof.

38. A method of making a three-dimensional, multi-layer article, which is resistant to damage caused by environmental factors, comprising:
forming an article comprising an engineering resin layer affixed to a commodity resin layer, such that during use of the article the engineering resin layer is exposed to adverse environmental conditions and the commodity layer is exposed to inert environmental conditions.

39. The method of claim 38, further comprising affixing the engineering resin layer to the commodity resin layer by disposing at least one tie layer between the engineering resin layer and the commodity resin layer.

40. The method of claim 39, further comprising forming the tie layer from a material selected from the group consisting of functionalized polyolefins, ethylene vinyl acetates, modified ethylene vinyl acetates, ethylene methyl acrylates, ethylene butyl acrylates, elastomers, polyester materials derived from dimethyl terephthalate or terephthalic acid, copolyester materials derived from dimethyl terephthalate or terephthalic acid, copolyester/polycarbonate alloys or blends, and mixtures thereof.

41. The method of claim 38, further comprising affixing the engineering resin layer to the commodity resin layer by disposing at least one adhesive layer between the engineering resin layer and the commodity resin layer.

42. The method of claim 41, further comprising forming the adhesive layer from a material selected from the group consisting of epoxy-based adhesives, urethane-based adhesives, and acrylic-based adhesives.

43. The method of claim 38, wherein at least one adverse environmental condition is selected from the group consisting of heat, chemicals, desiccants, oxygen, and weather.

44. The method of claim 38, further comprising forming the article by a forming method selected from the group consisting of injection molding, injection stretch blow molding, thermoforming, extrusion blow molding, insert molding, co-injection molding, and rotational molding.
